(19) United States
(12) Patent Application Publication
(10) Pub. No.: US 2008/0078154 A1
(43) Pub. Date: Apr. 3, 2008

(54) Fence mower

(76) Inventor: Larry D. Wright, Spring, TX (US)

Correspondence Address: LARRY D. WRIGHT, 1218 PINSON FORK DR., SPRING, TX, 77379, US

(21) Appl. No.: 11/542,020

(22) Filed: Oct. 3, 2006

(51) Int. Cl. A01D 75/18

(52) U.S. Cl. 56/10.4

(57) ABSTRACT

A fence mower attached to an agricultural tractor having a 3 point hitch in which the fence mower is used for cutting and mowing vegetation under the lowest or closest horizontal rail of a fence line and to both sides of the fence line where a fence line is a series of vertical post secured in the ground and connected to one another by horizontal rails.

### REFERENCE

Patent application Ser. No. 11/166,664 filed Jun. 24, 2005. Different design

### References Cited

U.S. PATENT DOCUMENTS

| | | |
|---|---|---|
| 3,526,083 | September 1970 | Barry and Watson |
| 4,573,306 | March 1986 | Alexander Smith; Burton D. Bagges |
| 5,035,107 | July 1991 | Scarborough |
| 5,065,566 | November 1991 | Gates |
| 5,694,752 | December 1997 | Warfield |
| 6,182,428 | February 2001 | Hatfield |
| 6,804,941 | October 2004 | Washburn |

### BACKGROUND OF THE INVENTION

1. Field of the Invention

The present invention relates to cutting (mowing) vegetation that grows under a fence line and to both sides of the fence line that cannot be mowed by conventional mowers due to the fence lines having horizontal rails that connect to a series of post. Fences have been in existence for some time and are used as boundaries as well as containment of livestock. Usually the horizontal rails are a series of several rails which the last rail or rail closest to the ground is only several inches off the ground.

The invention is hitched to the back of an agricultural tractor using a 3 point hitch. Power is supplied to the invention by the PTO (power take off) of the tractor. The invention is positioned under the last or lowest horizontal rail of a fence line. When the tractor is driven parallel to a fence line, the invention cuts and mows under the fence line as well as to both sides of the fence. When the invention encounters a fence post the invention will move around the post and reposition itself under the fence as the tractor continues to drive parallel to the fence line. The invention has an off set cutting blade which enables the invention to operate under horizontal fence rails that are only 6 inches above the ground.

2. Prior Art

Various machines are used to mow and to trim fence lines.

In U.S. Pat. No. 3,526,083 by Barry and Watson there is a mowing apparatus which will mow 360 degrees around a post and operates from just one side of the post. The invention relies on a figure eight cutting head. The invention titled Post Mower is used for mowing around road side signs, telephone poles, and other vertical post.

In U.S. Pat. No. 4,573,306 by Alexander Smith is a swing arm mower that extends outward from an agricultural tractor and when contacting fence post, trees or other fixed objects will hinge or move around the obstacle.

In U.S. Pat. No. 5,035,107 by Scarborough, an attachment is invented to attach to a rotary lawn mower. The attachment will trim around obstacles and also has a swing away action that will move around an obstacle like fence post or other objects.

In U.S. Pat. No. 5,065,566 by Gates, a flexible line trimmer is attached for a tractor driven mower deck and used for trimming around trees and other objects simultaneously with mowing.

In U.S. Pat. No. 5,694,752 by Warfield a utility expansion system is invented to be attached to a ground vehicle. The utility expansion system holds a portable line-fed power weed trimmer that is very common in residential lawn maintenance for trimming around trees and other ground maintenance.

In U.S. Pat. No. 6,182,428 by Hatfield a mowing apparatus is invented for trimming grass and weeds away from the base of a fence or around the foundation of a building (or exterior wall). This invention also has the ability to swing away from stationary objects in the path of the mower, and the invention relates to string cutters as its cutting method uses a string line to trim the grass and weeds. The invention is pulled by means of a tractor, ATV, or riding mower.

In U.S. Pat. No. 6,804,941 by Washburn a pull behind mower is invented for cutting ground vegetation and also has a method of swinging away when it contacts a fixed object like a fence post.

A need, therefore, exist for a mowing device that will mow under a fence line where the last or lowest fence rail is only inches above the ground.

The Fence Mower has now been invented that addresses this need. The Fence Mower has been tested and demonstrated in 23 states through out the United States and has over 50 such units in operation all made and manufactured by the inventor. It has addressed the problem of having an apparatus which can be used with an agricultural tractor and will mow under fence rails that are low to the ground surface. It has addressed the problem of miles of fence lines that are overgrown with vegetation by having an apparatus that can be attached to a tractor and cut under the fence lines that have several horizontal rails, the last rail or rail closest to the ground being only 6 inches above the ground. Driving throughout the country side and looking at miles and miles of fencing that are overgrown with vegetation attest for this need.

### SUMMARY OF THE INVENTION

It is, therefore, an objective of the present invention to provide a mowing apparatus. The mowing apparatus includes a 3 point hitch frame which can be attached to an agricultural tractor. A base frame is attached to the 3 point hitch frame. The base frame has a pivot pin to which a swing arm assembly is attached. The swing arm assembly is supported by the pivot pin and by one or more rollers. The swing arm assembly has an in line power system which is driven by a PTO drive line connected to the tractors PTO and the gear box of the in line power system. The in line power system has an offset blade attached to the underside of the spindle which performs the cutting and mowing as the off set blade is rotated.

It is also an objective of the present invention to have a spring system connecting the swing arm assembly to the base frame so when the swing arm assembly is pushed backwards when it encounters a fence post, the spring system will relocated the swing arm back under the fence line after clearing the fence post. Thus, allowing the operator of the tractor to drive in a line parallel to the fence line.

It is also an objective of the present invention to have the in line power system sand witched in the swing arm assembly with a 2 inch vertical dimension to allow the swing arm to go under a horizontal rail of a fence line that is only 6 inches above the ground.

It is also an objective of the present invention to have a tapered wedge nose at thee end of the swing arm assembly to be able to lift horizontal rails of the fence line that sag and touch the ground.

It is also an objective of the present invention to have a rounded bumper bar at the end of the tapered wedge nose to prevent the tapered wedge nose from cutting into a fence post as it engages the fence post so as to slide around the post.

It is also an objective of the present invention to have an offset blade connected to the under side of the spindle of the in line power system so that the off set blade at the sharpened ends will be at a higher vertical level than the point of attachment of the off set blade to the spindle.

Other objectives and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of the present fence mower.

FIG. 2 is a top view of the present fence mower.

FIG. 3 is a side view of the present fence mower.

FIG. 4 is a top view of the present fence mower when under the last or lowest horizontal fence rail as it approaches a fence post.

FIG. 5 is a top view of the present fence mower when it moves around a fence post showing the swing arm assembly being pushed backwards

FIG. 6 is a detail cross section side view of the in line power system and its relationship to the last or lowest horizontal fence rail.

FIG. 7 is a cross section side view of the spring system, pivot, and stop of the swing arm assembly and pivot connection to the base frame.

FIG. 8 is a detailed top view of the offset cutting blade.

FIG. 9 is a detail side view of the offset cutting blade.

### DESCRIPTION OF THE PREFERRED EMBODIMENTS

The detailed embodiment of the present invention is disclosed herein. It should be understood, however, that the disclosed embodiment is merely exemplary of the invention, which may be embodied in various forms. Therefore, the details disclosed herein are not to be interpreted as limited, but merely as a basis for the claims and as a basis for teaching one skilled in the art how to make and/or us the invention.

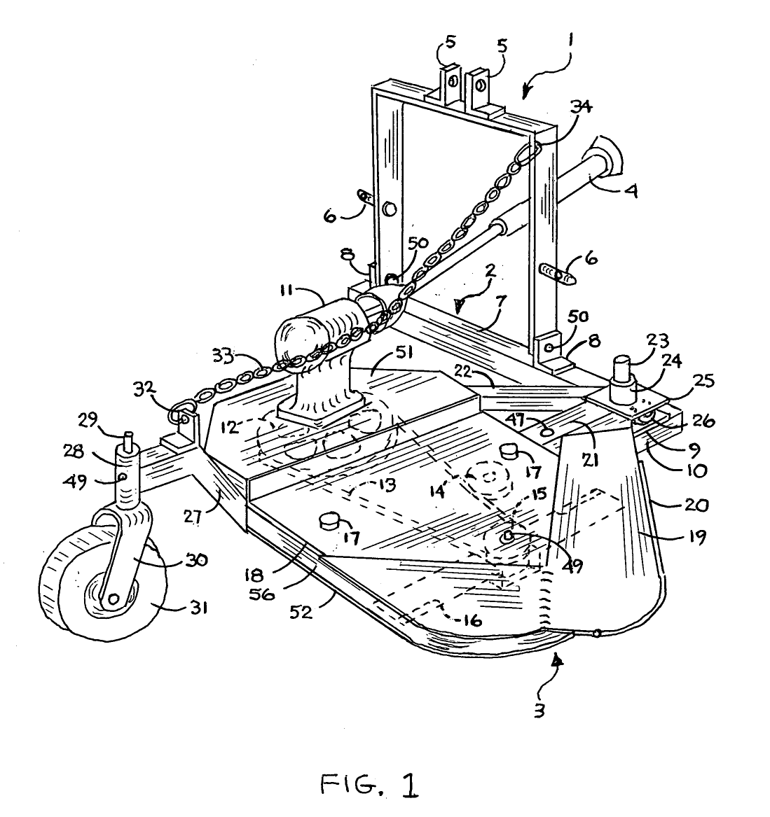

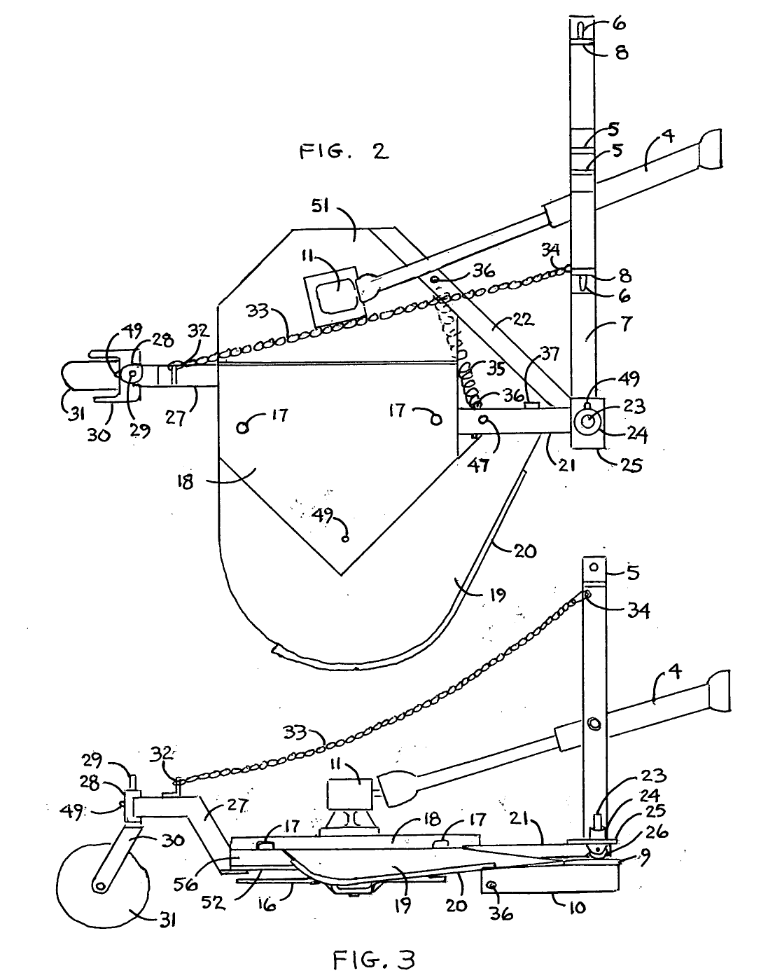

With reference to FIG. 1, a mowing apparatus show a fence mower having a 3 point hitch fame 1 attached to a base frame 2 which supports a swing arm assembly 3.

The 3 point hitch frame 1 consists of two brackets 5 to which the draw bar of the tractor is pinned (the tractor and its 3 point hitch is not shown). The 3 point hitch frame 1 also consists of two lifting pins 6 to which the lifting arms of the tractor is pinned (the tractor and its 3 point hitch is not shown). The 3 point hitch frame 1 is attached to the base frame 2 at the brackets 8 of the base frame 2 by means of bolts (not shown).

The base frame 2 consist of members 7 and 10 to which a plate 9 and pivot pin 23 is attached by welding.

The swing arm assembly 3 consist of members 21 and 22 to which a plate 25 is attached by welding. The swing arm assembly also consists of a sandwich containing mounting plate 51, side member 56, cover 18, a bottom plate 52 and rear wheel tail assembly member 27 attached to side member 56. A tapered wedge nose 20 is welded to members 21 and side member 56. Other details of the swing arm assembly 3 will be described later.

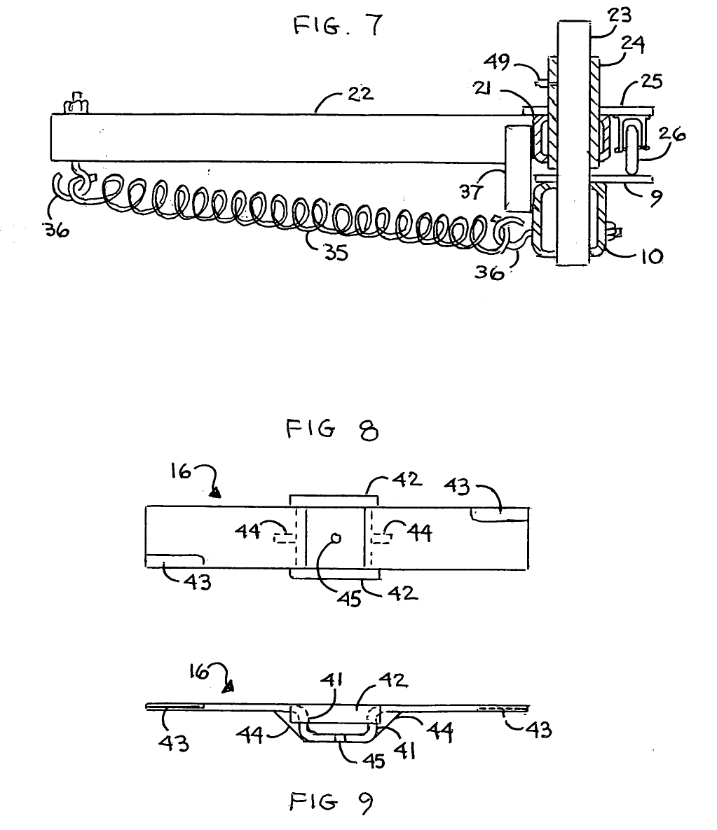

In FIG. 7 a housing 24 is welded in place having a hole drilled through plate 25, and member 24. The plate 25 has a roller 26 attached witch rides on plate 9 which is fixed to member 10 of the base frame 2. The roller 26 prevents the housing 24 from contacting plate 9 and therefore allows the members 21 and 22 and the housing 24 to rotate around the pivot pin 23 which is attached to plate 9 and member 10 of the base frame 2. The housing 24 has a grease fitting 49 to allow for lubrication of the pivot pin 23 within the housing 24. In FIG. 7 a stop 37 is welded to member 21 and will hit member 10 of the base frame 2. The stop 37 prevents the swing arm assembly 3 from rotating a forward direction past the base frame 2.

In FIG. 7 a spring 35 is attached by the use of eye bolts 36. One end of spring 35 is attached to an eye bolt 36 affixed to member 22 of the swing arm assembly 3 and the other end of the spring 35 is attached an eye bolt 36 affixed to member 10 of the base frame 2.

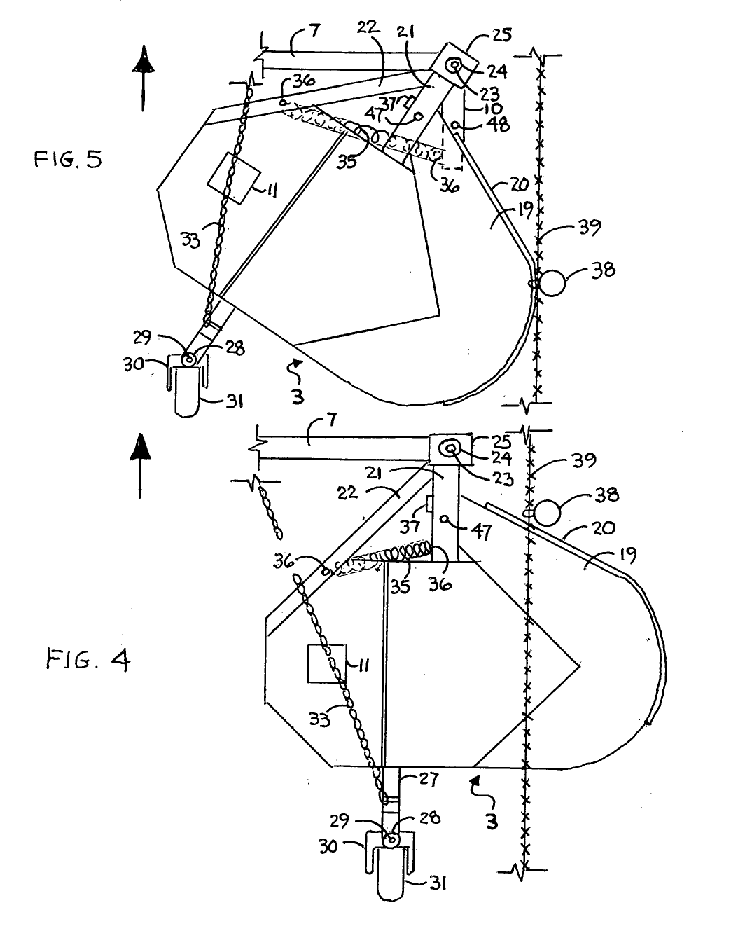

In FIG. 4 as the fence mower is moved forward by the tractor and the swing arm rounded bumper bar 20 hits a fence post 38, the forward movement of the tractor forces swing arm 3 in a backwards motion. The swing arm 3 being pivoted on the pivot pin 23 will move backwards until it is in position as shown in FIG. 5. In FIG. 5 the spring 35 is stretched. As the forward movement of the tractor continues, the rounded bumper bar 20 will clear the fence post 38. The spring 35 will pull back the swing arm 3 to its original position as shown back in FIG. 4.

In FIG. 1 there is shown a roller 31 which is affixed to a roller fork 30. The roller fork 30 has a pivot pin 29 which goes through a housing 28 which is welded to member 27 of the swing arm assembly 3. The roller 31 supports the swing arm assembly 3 off the ground in the rear while the roller 25 supports the swing arm assembly 3 in the front. The pivot pin 29 is lubricated by the grease fitting 49 which is screwed into the housing 28. This permits the roller 31 to rotate similar to a caster. In FIG. 4 and FIG. 5 it is shown how the roller 31 rotates its position as the swing arm assembly 3 moves around post 38.

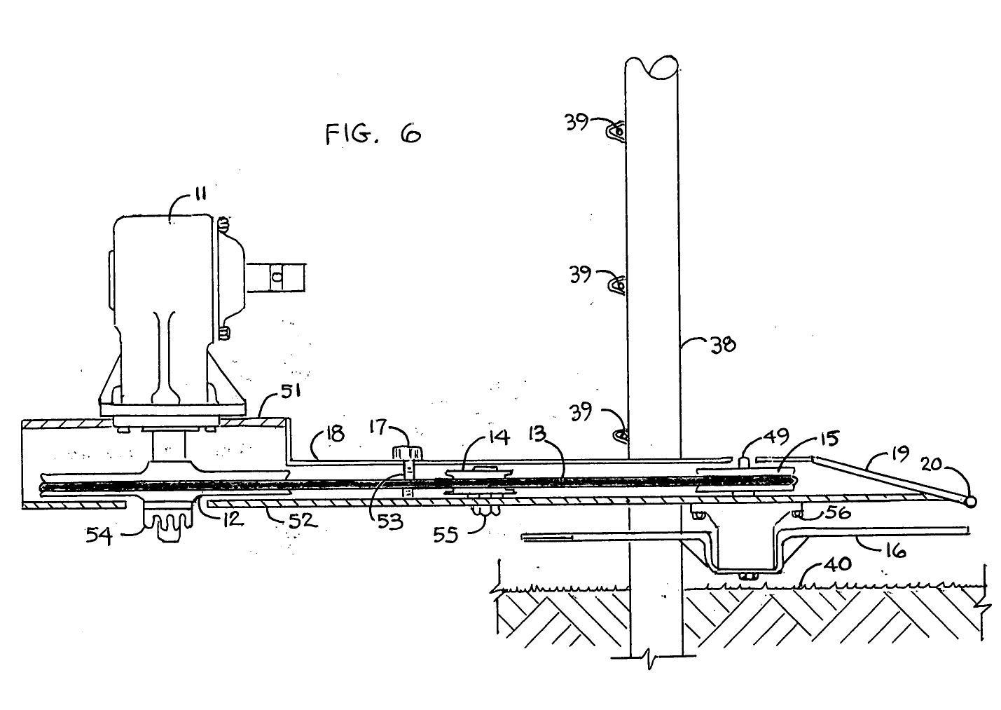

In FIG. 6 the swing arm assembly 3 sandwiches an in line power system which consist of a gear box 11 mounted to member 51 of the swing arm assembly 3. Attached to gear box 11 is a drive pulley 12 being attached to gear box 11 by means of a castle nut 54. Around the drive pulley 12 is a v belt 13 used in rotating the idler pulley 14 and the spindle with pulley 15. The under side of the spindle with pulley 15 is bolted an offset blade 16. The spindle with pulley 15 is affixed to the swing arm assembly member 52 by means of bolting 56.

In FIG. 1 a telescoping drive line 4 is attached to the PTO of the tractor (the tractor is not shown) and the other end of the telescoping drive line 4 is attached to the gear box 11. When the PTO of the tractor is engaged, the rotation of the PTO of the tractor rotates the telescoping drive line 4 which rotates the gear box 11. In FIG. 6, the rotation of the gear box 11 rotates the drive pulley 12 which rotates the v belt 13 with turns the idler pulley 14 and the spindle with pulley 15. The rotation of the spindle with pulley 15 rotates the attached off set blade 16 bolted to the under side of the spindle with pulley 15. The idler pulley 14 is adjustable in a horizontal slot (not shown) so as to keep the belt 13 tight against the drive pulley 12 and the spindle with pulley 15. The spindle with pulley 15 has a grease fitting 49 at the top to allow for lubrication.

FIG. 6 shows the relationship of the sandwiched in line drive system of the swing arm assembly 3 to the fence post 38 and the horizontal rails 39 which are fixed to the fence post 38. The flat sandwich allows the swing arm assembly 3 to go under the last or lowest fence rail without any interference. FIG. 6 also shows the relationship of the offset cutting blade 16 and the relationship to the ground 40 under the fence line comprised of fence post 38 and horizontal rails 39. The offset blade 16 having its cutting edges 43 in FIG. 9, well above the ground 40 surface.

The sandwiched of the swing arm assembly 3 is enclosed by a cover 18 which is placed on top of the swing arm assembly 3 and the cover 18 is held in place by a bolt 53 welded to member 52. Bolt 53 goes through a hole in cover 18 (hole not shown) and a knob 17 is screwed down on bolt 53 holding the cover 18 in place during operations. The cover 18 can be removed by unscrewing knobs 17 and lifting the cover 18 to expose the in line drive system, drive pulley 12, belt 13, idler pulley 14 and spindle with pulley 15 for assembly purposes and maintenance.

FIG. 8 and FIG. 9 show the off set cutting blade 16 in detail. The offset cutting blade 16 consist of a low alloy steel construction which is bent 41 to give an off set to the sharpened cutting edge 43 and the bolt connection 45. Two fabricated supports 44 are welded as well as two side supports 42. The offset cutting blade 16 will collar around the bottom of the pulley with spindle 15 when the off set cutting blade 16 is bolted 45 to the pulley with spindle 15.

In FIG. 4 a hole is drilled 47 in the swing arm assembly 3, member 21. In FIG. 5 a hole 48 is drilled in the base frame 2, member 10. The hole 47 will align with hole 48 when the swing arm assembly 3 is in the operating position as shown in FIG. 4. A pin (not shown) can be placed in hole 47 and hole 48 which will lock the swing arm assembly 3 in place with the base frame 2. When the fence mower is lifted up by the tractor using the tractor lifting mechanism, the chain 33 which is connected to the bracket 32 on the swing arm assembly 3 on one end, and is connected to the hole 34 on the 3 point hitch frame 1, will become tight and allow the fence mower to be lifted off the ground. This is for ease of transporting the fence mower from one location to another. During the operations of the fence mower, the pin through hole 47 and hole 48 must be removed to allow the swing arm assembly 3 to rotate around pivot pin 23.

In operating the fence mower, the operator will lower the fence mower to the ground to where the roller 31 touches the ground. The operator will lower the lifting arms of the tractor to give slack in chain 33 and to have the base frame 2 about 1 to 2 inches off the ground. The operator will position the fence mower under the fence line as shown in FIG. 4, and FIG. 6. As the operator engages the PTO of the tractor, the power system will rotate the offset cutting blade 16. The operator should run the rpm (revolutions per minute) of the PTO to 540 rpm, giving the offset cutting blade 16 a rotation of over 2,000 rpm. The operator will drive in low gear parallel to the fence line. As shown in FIG. 4 the fence mower will cut and mow directly under the fence line and to both sides. As the operator encounters a fence post, the operator will continue to drive parallel to the fence line and the forward motion of the tractor will push the swing arm assembly 3 backwards until the fence post is cleared. After clearing a fence post, the swing arm assembly 3 will come back under the fence line due to the spring 35. The operator continues to drive along the fence line and the fence mower repeats the cutting operation under the fence line from fence post to fence post.

The operator can transport the fence mower from one location to another simply by pinning the swing arm assembly 3 to the base frame 2 and lifting the fence mower off the ground with the tractor lifting arms.

What is claimed is:

1. A mowing apparatus which cuts vegetation under the lowest or last horizontal rail of a fence line and to each side of the fence line and the mowing apparatus comprising;
a 3 point hitch frame with lifting pins and drawl bar brackets which connects to an agricultural tractor;
a base frame which connects to the 3 point hitch frame and supports a swing arm assembly by means of a pivot pin;
a swing arm assembly connected to the base frame at the pivot pin and will swing around fence post by rotating around the pivot pin and supported by one or more rollers moving on top of the base frame;
a swing arm assembly having a spring connecting the swing arm assembly to the base frame;
a swing arm assembly sand witching an in line power system driven by a PTO drive line connected to the tractor and to the swing arm assembly gear box;
a swing arm assembly power system driving an offset cutting blade under neigh the swing arm assembly;
an offset cutting blade collaring the spindle of the in line power system and is sharpened so when rotated by the power system mows vegetation as the tractor is driven forward.

2. The mowing apparatus according to claim 1, wherein the sand witch in line power system is positioned under the lowest horizontal rail of a fence line in a position which will mow directly under the lowest horizontal rail and to both sides of the fence line.

3. The mowing apparatus according to claim 2, wherein the sand witch has a tapered wedge nose at the end to lift the lowest horizontal rail upwards when there exist conditions of the lowest horizontal rail to sag and come in contact with the ground.

4. The mowing apparatus according to claim 3, wherein the tapered wedge nose has a rounded bumper bar so as when coming in contact with a fence post will not cut into the fence post as the mowing apparatus is driven forward and the bumper bar slides around the post and repositioning itself under the lowest horizontal rail of the fence line.

5. The mowing apparatus according to claim 1 having a spring that is attached at one end to the base frame and the other end attached to the swing arm assembly so that when the swing arm assembly encounters a fence post and is pushed backwards, the spring will return the swing arm back to its original position after clearing the fence post.

6. The mowing apparatus according to claim 1 having an offset cutting blade which collars the spindle and is curved so that in the vertical dimension the sharpened ends of the offset cutting blade are a greater distance off the ground than the bottom of the spindle where the offset cutting blade is attached.
